(19) United States
(12) Patent Application Publication
(10) Pub. No.: US 2021/0261422 A1
(43) Pub. Date: Aug. 26, 2021

(54) MAGNETIC NANO COMPOSITE MATERIAL BASED ON TWO-DIMENSIONAL LAYERED MATERIAL MAGADIITE, AND PREPARATION METHOD AND APPLICATION THEREOF

(71) Applicant: SOUTH CHINA UNIVERSITY OF TECHNOLOGY, Guangzhou, Guangdong (CN)

(72) Inventors: Mingliang GE, Guangdong (CN); Caiping ZHU, Guangdong (CN)

(73) Assignee: South China University of Technology, Guangzhou, Guangdong (CN)

(21) Appl. No.: 17/053,797

(22) PCT Filed: Oct. 31, 2018
(86) PCT No.: PCT/CN2018/113223

§ 371 Date: Nov. 9, 2020

(30) Foreign Application Priority Data
May 15, 2018 (CN) 201810460989.2

(51) Int. Cl. C01B 33/40; C02F 1/48; B01J 20/10; B01J 20/28

(52) U.S. Cl. CPC C01B 33/405; C02F 1/488; C02F 2101/308; B01J 20/28009; B01J 20/10

(57) ABSTRACT

A magnetic nano composite material based on two-dimensional layered material magadiite, and a preparation method and an application thereof are provided. A co-precipitation method is used for one-step synthesis of the magnetic nano composite material based on the two-dimensional layered material magadiite. In the synthesized composite material, ferroferric oxide is uniformly supported on an interlayer and a surface of the magadiite. The composite material is applied for removing organic dyes in water pollution.

### TECHNICAL FIELD

The present invention relates to the field of magnetic nano composite materials, and more particularly, to a magnetic nano composite material based on two-dimensional layered material magadiite, and a preparation method and an application thereof.

### BACKGROUND

Magadiite (MD) is a rose petal-shaped layered silicate material, which presents a good expansibility between layers and has a strong adsorption capacity for water and some small polar organic molecules. There are negative charges between the layers, which can exchange ions with cations, and an ion exchange capacity is relatively high. There are a lot of active hydroxyl groups on a magadiite lamella, which can be functionally modified. The magadiite has a relatively large specific surface area and a relatively strong adsorption capacity, and has an outstanding application value in fields of nano composite materials, adsorption materials, catalyst carriers, zeolite molecular sieves and the like.

Ferroferric oxide is a strongly magnetic nanoparticle with a relatively large specific surface area, a superparamagnetism and a good biocompatibility, but is easy to agglomerate, which seriously affects catalytic and adsorption performances thereof. When the magadiite is combined with the ferroferric oxide, the ferroferric oxide is supported on the magadiite, which not only solves a problem that the ferroferric oxide is easy to agglomerate, but also makes the ferroferric oxide easy to separate, thus being beneficial for improving the adsorption performance thereof, and having a broad application prospect in solid-liquid separation, pollutant adsorption, catalysis, targeted drugs, and other aspects.

The magnetic material may be used as a new environmental purification material, which can be rapidly separated under an external magnetic field without secondary pollution in water processing.

### SUMMARY

The present invention aims to provide a magnetic nano composite material based on two-dimensional layered material magadiite, which is specifically a magadiite/ferroferric oxide nano composite material. The magnetic nano composite material has a good adsorption effect on methylene blue in an aqueous solution.

The present invention further aims to provide a preparation method of the magnetic nano composite material based on the two-dimensional layered material magadiite. According to the preparation method, ferroferric oxide is supported on a surface of magadiite, so that the nano composite material is endowed with a magnetism, and meanwhile, a dispersibility of the ferroferric oxide is improved, particle agglomeration is prevented, and the preparation method is simple and costs are low.

The present invention further aims to provide an application of the magnetic nano composite material based on the two-dimensional layered material magadiite, and specifically, the magnetic nano composite material based on the two-dimensional layered material magadiite is used for removing organic dyes in water pollution.

The objectives of the present invention are achieved by the following technical solutions.

According to a preparation method of a magnetic nano composite material based on two-dimensional layered material magadiite, ferrous salt, ferric salt and an alkali liquor are used as raw materials, and ferroferric oxide particles are supported on an interlayer and a surface of the magadiite by a co-precipitation method, and the preparation method specifically includes the following steps:
(1) uniformly dispersing magadiite in distilled water by ultrasonic processing and stirring to obtain a dispersion liquid of the magadiite;
(2) under protection of nitrogen, dissolving soluble ferrous salt and soluble ferric salt in distilled water, and stirring and dispersing the mixture uniformly to obtain an iron salt solution; and
(3) under protection of nitrogen, adding the dispersion liquid of the magadiite into the iron salt solution while stirring to obtain a mixed solution, heating the mixed solution, adding an alkali liquor to adjust a pH value of the mixed solution to be strongly alkaline, carrying out a co-precipitation reaction while stirring, cooling to a room temperature after reaction, washing, drying and grinding precipitates to obtain a magadiite/ferroferric oxide magnetic nano composite material, which is namely the magnetic nano composite material based on the two-dimensional layered material magadiite.

Further, in the step (1), the ultrasonic processing lasts for 10 minutes to 30 minutes.

Further, in the step (1), the stirring lasts for 6 hours to 12 hours.

Further, in the step (1), a concentration of the dispersion liquid of the magadiite is 0.02 g/mL to 0.05 g/mL.

Further, in the step (2), the soluble ferrous salt is one of ferrous sulfate, ferrous chloride and ferrous nitrate.

Further, in the step (2), the soluble ferric salt is ferric chloride or anhydrous ferric chloride.

Further, in the step (2), in the iron salt solution, a molar ratio of the ferrous salt to the ferric salt is 1:2 to 5:4.

Further, in the step (2), a concentration of the iron salt solution is 0.0100 g/mL to 0.0164 g/mL.

Further, in the step (3), a mixed volume ratio of the dispersion liquid of the magadiite to the iron salt solution is 1:1.

Further, in the step (3), the heating is to heat the mixed solution to 50° C. to 95° C.

Further, in the step (3), the alkali liquor is a sodium hydroxide solution or ammonia water.

Further, in the step (3), the alkali liquor is added to adjust the pH value of the mixed solution to 9 to 12.

Further, in the step (3), the co-precipitation reaction lasts for 1 hour to 2 hours.

Further, in the step (3), the washing is to wash the precipitates for three times with absolute ethyl alcohol.

Further, in the step (3), the drying is to dry the precipitates under vacuum at 40° C. to 80° C. to a constant weight.

A magnetic nano composite material based on two-dimensional layered material magadiite prepared according to any one of the preparation method mentioned above.

The magnetic nano composite material based on the two-dimensional layered material magadiite is used for removing organic dyes in water pollution, including being used for removing methylene blue, rhodamine B or methyl orange in the water pollution.

Further preferably, the magnetic nano composite material based on the two-dimensional layered material magadiite is used for adsorbing and removing a cationic dye of methylene blue in aqueous solution.

Compared with the prior art, the present invention has the following advantages and beneficial effects that:
(1) the magadiite/ferroferric oxide magnetic nano composite material synthesized in one step by the co-precipitation method in the present invention has a larger specific surface area, and also integrates a paramagnetism and a biocompatibility of the ferroferric oxide and an ion exchange performance and an adsorbability of the magadiite;
(2) in the magadiite/ferroferric oxide magnetic nano composite material synthesized in the present invention, the ferroferric oxide is uniformly supported on the interlayer and the surface of the magadiite, solving the problems of easy agglomeration of ferroferric oxide nanoparticles and difficult separation of the magadiite as an adsorbent;
(3) a preparation process of the magadiite/ferroferric oxide magnetic nano composite material provided by the present invention is simple, where operation is easy, raw materials do not contain any harmful substances, environmental protection and energy saving are realized, costs are low, and production is easily industrialized;
(4) the magadiite/ferroferric oxide magnetic nano composite material of the present invention is applied for removing organic dyes in water pollution, which expresses a good adsorbability, and can be rapidly separated under the action of an external magnetic field, and especially has a good adsorption effect on the methylene blue in the aqueous solution; and
(5) the magadiite/ferroferric oxide magnetic nano composite material prepared by the present invention has a good magnetism, can move and aggregate rapidly under the action of the external magnetic field, and has a good adsorption performance, thus having a broad application prospect in fields of environmental protection, bioseparation, biomedicine and the like.

### BRIEF DESCRIPTION OF THE DRAWINGS

FIG. 1 is a Fourier transform infrared spectrum of a magadiite/ferroferric oxide magnetic nano composite material synthesized in Embodiment 1;

FIG. 2 is an XRD spectrum of pure magadiite, Fe₃O₄ and the magadiite/ferroferric oxide magnetic nano composite material synthesized in Embodiment 1;

FIG. 3 is a hysteresis loop diagram of the magadiite/ferroferric oxide magnetic nano composite material synthesized in Embodiment 1;

FIG. 4a, FIG. 4b and FIG. 4c are respectively Scanning Electron Microscope (SEM) images of pure magadiite and magadiite/ferroferric oxide magnetic nano composite materials synthesized in Embodiment 1 and Embodiment 2;

FIG. 5 is a curve graph of a change of a unit adsorption capacity of the magadiite/ferroferric oxide composite material on a rhodamine B solution with adsorption time in Embodiment 2; and

FIG. 6 is a curve graph of a change of a unit adsorption capacity of magadiite/ferroferric oxide composite material on a methylene blue solution with adsorption time in Embodiment 3.

### DETAILED DESCRIPTION

The technical solutions of the present invention are further described in detail hereinafter with reference to the specific embodiments and the accompanying drawings, but the specific embodiments and the scope of protection of the present invention are not limited to the embodiments and the accompanying drawings.

### Embodiment 1

Preparation of a magadiite/ferroferric oxide magnetic nano composite material included the following steps.

(1) 2.5 g of magadiite was weighed and added into 50 mL of distilled water, ultrasonically dispersed for 30 minutes, and then stirred in a magnetic stirrer for 12 hours to obtain a dispersion liquid of the magadiite.

(2) 0.2982 g of FeCl₂.4H₂O and 0.3244 g of anhydrous FeCl₃ were weighed and added into 50 mL of distilled water, and stirred and dissolved to obtain an iron salt solution.

(3) Under stirring and protection of N₂, the dispersion liquid of the magadiite in the step (1) was added into the iron salt solution in the step (2) to obtain a mixed solution, the mixed solution was heated to 80° C., then dropwise added with a sodium hydroxide solution to adjust a pH to 11, continuously subjected to a magnetic stirring reaction for 2 hours under the protection of N₂, and cooled to a room temperature, and precipitates were washed with absolute ethyl alcohol for three times, dried under vacuum to a constant weight at 60° C., and ground to obtain the magadiite/ferroferric oxide magnetic nano composite material.

According to nitrogen adsorption and desorption testing and BET equation calculation, the prepared magadiite/ferroferric oxide had a specific surface area of 72 m²/g, which was much higher than a specific surface area (21 m²/g) of pure magadiite.

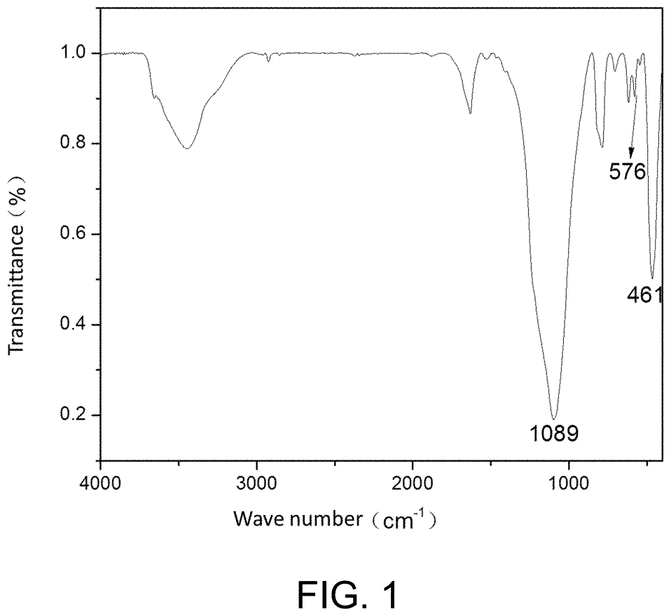

FIG. 1 shows a Fourier transform infrared spectrum of the synthesized magadiite/ferroferric oxide magnetic nano composite material. It can be seen from FIG. 1 that the magadiite/ferroferric oxide nano composite material contains a symmetrical stretching vibration absorption peak (1089 cm⁻¹) and a bending vibration peak (461 cm⁻¹) of Si—O—Si from a [SiO₄] tetrahedron of the magadiite, and meanwhile also contains a Fe—O vibration absorption peak (576 cm⁻¹) from the ferroferric oxide, indicating that the ferroferric oxide is successfully supported on the magadiite.

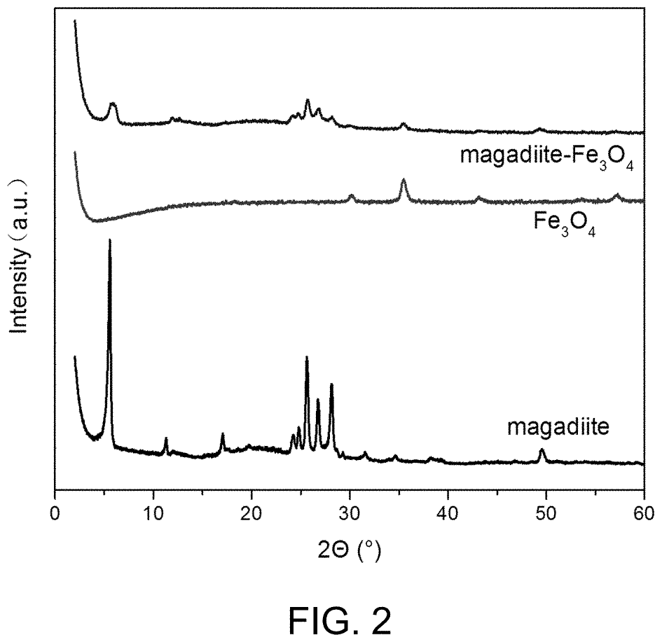

FIG. 2 shows an XRD spectrum of pure magadiite, Fe₃O₄ and the synthesized magadiite/ferroferric oxide magnetic nano composite material. It can be seen from FIG. 2 that a magnestism of the magadiite/ferroferric oxide contains diffraction peaks of the magadiite and the Fe₃O₄ simultaneously, which further indicates that the magadiite/ferroferric oxide magnetic nano composite material is successfully synthesized by a co-precipitation method.

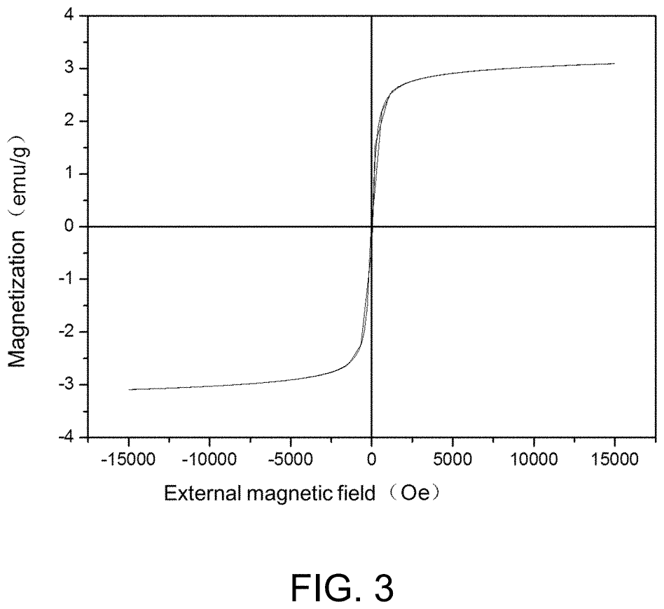

FIG. 3 shows a hysteresis loop diagram of the synthesized magadiite/ferroferric oxide magnetic nano composite material. It can be seen from FIG. 3 that the magadiite/ferroferric oxide magnetic nano composite material has a good paramagnetism.

### Embodiment 2

Preparation of a magadiite/ferroferric oxide magnetic nano composite material included the following steps.

(1) 1 g of magadiite was weighed and added into 50 mL of distilled water, ultrasonically dispersed for 10 minutes, and then stirred in a magnetic stirrer for 6 hours to obtain a dispersion liquid of the magadiite.

(2) 0.1988 g of FeCl₂.4H₂O and 0.3244 g of anhydrous FeCl₃ were weighed and added into 50 mL of distilled water, and stirred and dissolved to obtain an iron salt solution.

(3) Under stirring and protection of N₂, the dispersion liquid of the magadiite in the step (1) was added into the iron salt solution in the step (2) to obtain a mixed solution, the mixed solution was heated to 50° C., then dropwise added with a sodium hydroxide solution to adjust a pH to 9, continuously subjected to a magnetic stirring reaction for 1 hour under the protection of N₂, and cooled to a room temperature, and precipitates were washed with absolute ethyl alcohol for three times, dried under vacuum to a constant weight at 80° C., and ground to obtain the magadiite/ferroferric oxide magnetic nano composite material.

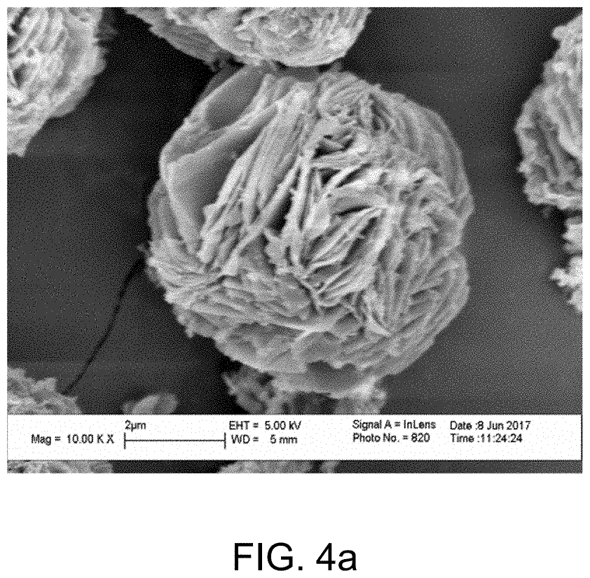

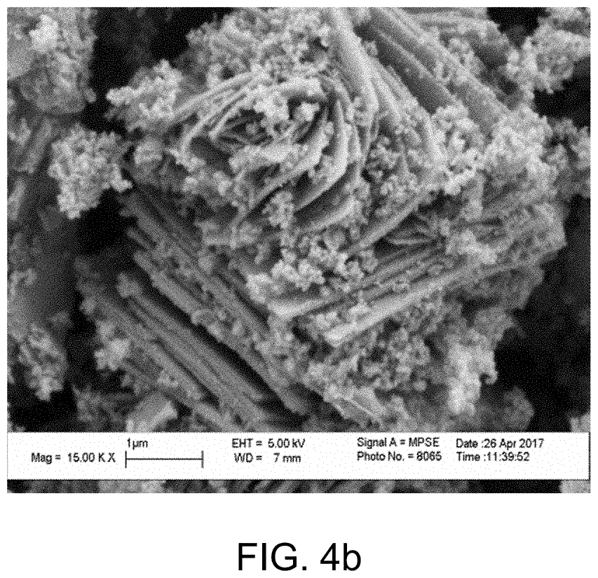

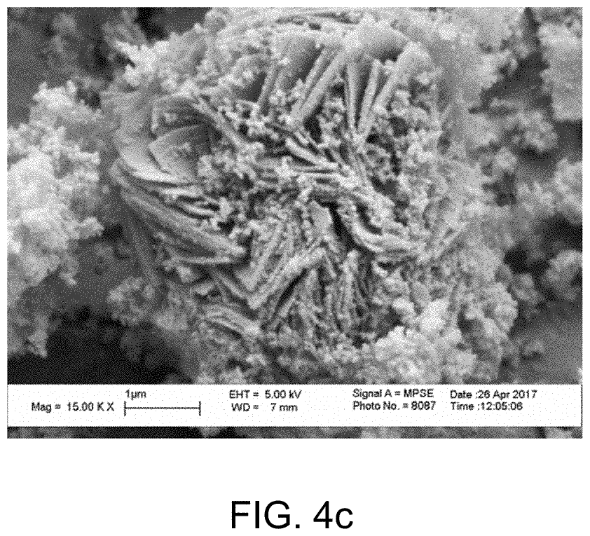

FIG. 4a, FIG. 4b and FIG. 4c respectively show Scanning Electron Microscope images of pure magadiite and magadiite/ferroferric oxide magnetic nano composite materials synthesized in the Embodiment 1 and Embodiment 2. It can be seen from FIG. 4a, FIG. 4b and FIG. 4c that the ferroferric oxide can be uniformly supported on the interlayer and the surface of the magadiite.

The magadiite/ferroferric oxide magnetic nano composite material prepared by the above steps was used for adsorbing a cationic dye of rhodamine B in an aqueous solution, including the following steps.

(1) A rhodamine B aqueous solution with a concentration of 1 g/L was prepared and used as a stock solution, and then the stock solution was diluted into a rhodamine B solution with a concentration of 100 mg/L.

(2) 50 ml of the 100 mg/L rhodamine B solution was taken and a pH value thereof was adjusted to 7, then added with 50 mg of magadiite/ferroferric oxide composite material (i.e., a concentration of an adsorbent was 1 g/L), and adsorption was carried out at a room temperature for 5 minutes, 10 minutes, 20 minutes, 30 minutes, 40 minutes, 60 minutes, 90 minutes and 120 minutes, and an absorbance of a supernatant was measured with an ultraviolet spectrophotometer to obtain a concentration of the rhodamine B remained in the solution, thus obtaining a curve of a change of a unit adsorption capacity of the adsorbent magadiite/ferroferric oxide composite material on the rhodamine B solution with absorption time.

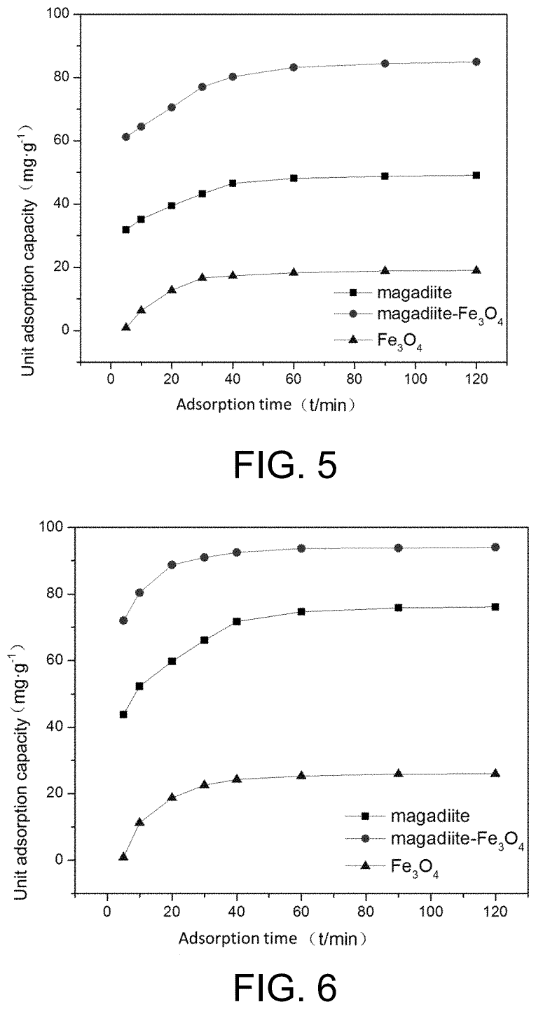

FIG. 5 shows a curve graph of the change of the unit adsorption capacity of the magadiite/ferroferric oxide composite material on the rhodamine B solution with the adsorption time. It can be seen from FIG. 5 that an adsorption performance of the magadiite/ferroferric oxide composite material on the rhodamine B solution is better than that of pure magadiite and pure ferroferric oxide.

### Embodiment 3

Preparation of a magadiite/ferroferric oxide magnetic nano composite material included the following steps.

(1) 2 g of magadiite was weighed and added into 50 mL of distilled water, ultrasonically dispersed for 20 minutes, and then stirred in a magnetic stirrer for 8 hours to obtain a dispersion liquid of the magadiite.

(2) 0.497 g of FeCl₂.4H₂O and 0.3244 g of anhydrous FeCl₃ were weighed and added into 50 mL of distilled water, and stirred and dissolved to obtain an iron salt solution.

(3) Under stirring and protection of N₂, the dispersion liquid of the magadiite in the step (1) was added into the iron salt solution in the step (2) to obtain a mixed solution, the mixed solution was heated to 95° C., then dropwise added with a sodium hydroxide solution to adjust a pH to 12, continuously subjected to a magnetic stirring reaction for 1.5 hours under the protection of N₂, and cooled to a room temperature, and precipitate were washed with absolute ethyl alcohol for three times, dried under vacuum to a constant weight at 40° C., and ground to obtain the magadiite/ferroferric oxide magnetic nano composite material.

The magadiite/ferroferric oxide magnetic nano composite material prepared by the above steps was used for adsorbing a cationic dye of methylene blue in an aqueous solution, including the following steps.

(1) 1 g of methylene blue dye was weighed and dissolved with deionized water, prepared into a standard solution of methylene blue with a concentration of 1 g/L, and then the standard solution was diluted into 100 mg/L methylene blue dye solution.

(2) 50 ml of the 100 mg/L methylene blue solution was taken and a pH value thereof was adjusted to 7, then added with 50 mg of magadiite/ferroferric oxide composite material (i.e., a concentration of an adsorbent was 1 g/L), and adsorption was carried out at a room temperature for 5 minutes, 10 minutes, 20 minutes, 30 minutes, 40 minutes, 60 minutes, 90 minutes and 120 minutes, sampling was carried out, and an absorbance of a supernatant was measured with an ultraviolet spectrophotometer to obtain a concentration of the methylene blue remained in the solution, thus obtaining a curve of a change of a unit adsorption capacity of the adsorbent magadiite/ferroferric oxide composite material on the methylene blue solution with absorption time.

FIG. 6 shows a curve graph of the change of the unit adsorption capacity of the magadiite/ferroferric oxide composite material on the methylene blue solution with the adsorption time. It can be seen from FIG. 6 that a unit adsorption capacity of the magnetic nano composite material with the concentration of 1 g/L on the 100 mg/L methylene blue solution may reach 95 mg/g, which is much higher than a unit adsorption capacity of pure magadiite and pure ferroferric oxide on the methylene blue solution.

The above embodiments are merely the preferred embodiments of the present invention, which are only used to explain the present invention, but are not intended to limit the present invention. Any changes, substitutions, combinations, simplifications and modifications made by those skilled in the art without departing from the spirit and principle of the present invention shall be equivalent substitutions and shall be included in the scope of protection of the present invention.

1. A preparation method of a magnetic nano composite material based on two-dimensional layered material magadiite, the method comprises the following steps:
(1) uniformly dispersing magadiite in distilled water by ultrasonic processing and stirring to obtain a dispersion liquid of the magadiite;
(2) under protection of nitrogen, dissolving soluble ferrous salt and soluble ferric salt in distilled water, and stirring and dispersing the mixture uniformly to obtain an iron salt solution; and
(3) under protection of nitrogen, adding the dispersion liquid of the magadiite into the iron salt solution while stirring to obtain a mixed solution, heating the mixed solution, adding an alkali liquor to adjust a pH value of the mixed solution to be strongly alkaline, carrying out a co-precipitation reaction while stirring, cooling to a room temperature after reaction, washing, drying and grinding precipitates to obtain a magadiite/ferroferric oxide magnetic nano composite material, which is namely the magnetic nano composite material based on the two-dimensional layered material magadiite.

2. The preparation method according to claim 1, wherein, in the step (1), a concentration of the dispersion liquid of the magadiite is 0.02 g/mL to 0.05 g/mL.

3. The preparation method according to claim 1, wherein, in the step (2), the soluble ferrous salt is one of ferrous sulfate, ferrous chloride and ferrous nitrate; and the soluble ferric salt is ferric chloride or anhydrous ferric chloride.

4. The preparation method according to claim 1, wherein, in the step (2), a molar ratio of the ferrous salt to the ferric salt is 1:2 to 5:4.

5. The preparation method according to claim 1, wherein, in the step (3), a mixed volume ratio of the dispersion liquid of the magadiite to the iron salt solution is 1:1.

6. The preparation method according to claim 1, wherein, in the step (3), the heating is to heat the mixed solution to 50° C. to 95° C.

7. The preparation method according to claim 1, wherein, in the step (3), the alkali liquor is a sodium hydroxide solution or ammonia water; and the alkali liquor is added to adjust the pH value of the mixed solution to 9 to 12.

8. The preparation method according to claim 1, wherein, in the step (3),
the co-precipitation reaction lasts for 1 hour to 2 hours;
the washing is to wash the precipitates for three times with absolute ethyl alcohol; and
the drying is to dry the precipitates under vacuum at 40° C. to 80° C. to a constant weight.

9. A magnetic nano composite material based on two-dimensional layered material magadiite prepared by the preparation method according to claim 1.

10. An application of the magnetic nano composite material based on the two-dimensional layered material magadiite according to claim 9 for removing organic dyes in water pollution, wherein the organic dyes comprise methylene blue, rhodamine B or methyl orange.

11. A magnetic nano composite material based on two-dimensional layered material magadiite prepared by the preparation method according to claim 2.

12. A magnetic nano composite material based on two-dimensional layered material magadiite prepared by the preparation method according to claim 3.

13. A magnetic nano composite material based on two-dimensional layered material magadiite prepared by the preparation method according to claim 4.

14. A magnetic nano composite material based on two-dimensional layered material magadiite prepared by the preparation method according to claim 5.

15. A magnetic nano composite material based on two-dimensional layered material magadiite prepared by the preparation method according to claim 6.

16. A magnetic nano composite material based on two-dimensional layered material magadiite prepared by the preparation method according to claim 7.

17. A magnetic nano composite material based on two-dimensional layered material magadiite prepared by the preparation method according to claim 8.
